(19) United States
(12) Patent Application Publication
(10) Pub. No.: US 2018/0247587 A1
(43) Pub. Date: Aug. 30, 2018

(54) DISPLAY DEVICE AND ELECTRONIC APPARATUS

(71) Applicant: Sony Corporation, Tokyo (JP)

(72) Inventor: Kei Kimura, Kanagawa (JP)

(21) Appl. No.: 15/578,010

(22) PCT Filed: Apr. 20, 2016
(86) PCT No.: PCT/JP2016/062545

§ 371 Date: Nov. 29, 2017

(30) Foreign Application Priority Data
Jun. 15, 2015 (JP) 2015-119923

(51) Int. Cl. G09G 3/3225

(52) U.S. Cl. CPC G09G 3/3225; G09G 2300/0452; G09G 2310/0205; G09G 2320/0219

(57) ABSTRACT

A display device of the present disclosure includes: a pixel array unit in which pixels each including a light emitting portion are arranged in a matrix form; and a video signal supply unit adapted to supply a video signal to a signal line provided for each pixel column of the pixel array unit. Additionally, the video signal supply unit includes drivers of a plurality of systems provided in a manner corresponding to a plurality of adjacent signal lines. An electronic apparatus of the present disclosure includes the display device having the above-described configuration.

### TECHNICAL FIELD

The present disclosure relates to a display device and an electronic apparatus.

### BACKGROUND ART

In a display device in which pixels each including a light emitting portion are arranged in a matrix form and a video signal is supplied to each of the pixels through a signal line provided per pixel column, coupling via a parasitic capacitor may occur between adjacent signal lines when supply timings (writing timings) of video signals to the adjacent signal lines are different. Accordingly, even in a case where video signals each having a same level may be written in the adjacent signal lines, a difference is generated between signal levels of the adjacent pixels at the time of writing the video signals in the pixels As a result, drive current of the light emitting portion becomes different between the adjacent pixels, and therefore, noise formed along a pixel column, namely, vertical stripe-like noise may be generated and visually recognized as a uniformity defect.

### CITATION LIST

### Patent Document

Patent Document 1: Japanese Patent Application Laid-Open No. 2004-102319

### SUMMARY OF THE INVENTION

### Problems to be Solved by the Invention

Patent Document 1 discloses an invention related to a display device in which a shield portion is provided between adjacent pixel columns in order to suppress influence from adjacent pixels caused by coupling, however; since the shield portion is provided per pixel column, not only miniaturization of a pixel unit but also improvement of definition are hindered. Here, the term “pixel unit” represents a constituent unit that includes one pixel (or a sub-pixel), wiring, and the like in a periphery thereof per pixel (per sub-pixel unit).

The present disclosure is directed to providing a display device achieving not only miniaturization of a pixel unit but also improvement of definition, and an electronic apparatus having the display device.

### Solutions to Problems

A display device of the present disclosure provided to achieve the above objects includes:

a pixel array unit in which pixels each including a light emitting portion are arranged in a matrix form; and

a video signal supply unit adapted to supply a video signal to a signal line provided per pixel column of the pixel array unit,

in which the video signal supply unit includes drivers of a plurality of systems provided in a manner corresponding to a plurality of adjacent signal lines. Additionally, an electronic apparatus of the present disclosure provided in order to achieve the above-described objects includes a display device having the above-configuration.

Since the video signal supply unit includes the drivers of the plurality of systems provided in a manner corresponding to the plurality of adjacent signal lines, video signals can be supplied to the plurality of adjacent signal lines at the same timing from each of the drivers of the plurality of systems. Furthermore, since the supply timings of the video signals to the plurality of adjacent signal lines are the same, no coupling occurs even in a case where a parasitic capacitor exists between the plurality of adjacent signal lines. With this configuration, deterioration of uniformity caused by coupling can be prevented even in a case of providing no shield portion between the plurality of adjacent signal lines.

### Effects of the Invention

According to the present disclosure, since deterioration of uniformity caused by coupling can be prevented even in the case of providing no shield portion between the plurality of adjacent signal lines, not only the pixel unit can be miniaturized by an amount of the shield portion that can be omitted but also definition of the display device can be improved.

Note that effects are not limited to those recited herein but may be any one of those recited in the present specification. Additionally, note that the effects described in the present specification are only examples and not limited thereto, and further additional effects may also be provided.

### BRIEF DESCRIPTION OF DRAWINGS

FIG. 1 is a system configuration diagram schematically illustrating a basic configuration of an active matrix organic EL display device.

FIG. 2 is a circuit diagram illustrating an exemplary circuit configuration of a pixel (pixel circuit).

FIG. 3 is a timing waveform chart to describe exemplary basic circuit operation of the active matrix organic EL display device.

FIG. 4 is a block diagram illustrating an exemplary configuration of a video signal supply unit according to an example in the related art.

FIG. 5A is a diagram illustrating details of respective switches SW₁ to SW₆ and selection signals SEL₁ to SEL₆ of a switch circuit in the video signal supply unit according to the example in the related art, and FIG. 5B is a timing waveform chart illustrating waveforms of the selection signals SEL₁ and SEL₂ and potentials Sig₁ and Sig₂ of adjacent signal lines.

FIG. 6 is a block diagram illustrating an exemplary configuration of a video signal supply unit according to Example 1.

FIG. 7A is a diagram illustrating details of respective switches SW₁ to SW₄ and selection signals SEL₁ to SEL₄ of a switch circuit in the video signal supply unit according to the Example 1, and FIG. 7B is a timing waveform chart illustrating the selection signals SEL₁ and SEL₂ and potentials Sig₁ (upper) and Sig₁ (lower) of adjacent signal lines.

FIG. 8 is a block diagram illustrating an exemplary configuration of a video signal supply unit according to Example 2.

FIG. 9 is a plan pattern diagram schematically illustrating exemplary arrangement of constituent elements of pixels according to the Example 2.

FIG. 10A is a diagram illustrating a color array in a case where four sub-pixels RGBW are arranged in a stripe array, and FIG. 10B is a diagram illustrating a color array in a case where four sub-pixels RGBW are arranged in a square array.

FIG. 11 is a block diagram illustrating an exemplary configuration of a video signal supply unit according to Example 3 in a case of a stripe array.

FIG. 12 is a waveform chart of selection signals to drive switches of respective pixel columns and video signals to be supplied to the respective signal line.

FIG. 13A is a perspective view schematically illustrating a wiring structure of a square array according to a first modified example, and FIG. 13B is a wiring diagram schematically illustrating a wiring structure of a square array according to a second modified example.

FIG. 14 is a circuit diagram illustrating another exemplary circuit configuration of a pixel (pixel circuit).

FIG. 15A is a front view of a single lens reflex digital still camera with a lens interchangeable, and FIG. 15B is a rear view of the digital still camera.

FIG. 16 is an external view of a head mounted display.

### MODE FOR CARRYING OUT THE INVENTION

In the following, a mode (hereinafter referred to as “embodiment”) to implement the technology of the present disclosure will be described in detail with reference to the drawings. The technology of the present disclosure is not limited to the embodiment, and various numerical values, materials, and the like in the embodiments are examples. In the following description, a same reference sign will be used for a same element or an element having a same function, and repetition of the same description will be omitted. Note that the description will be provided in the following order.

1. General Description of Display Device and Electronic Apparatus of the Present Disclosure

2. Display Device to Which Technology of the Present Disclosure is Applied

2-1. System Configuration

2-2. Pixel Circuit

2-3. Basic Circuit Operation

2-4. Selector Driving System

3. One Embodiment of Present Disclosure

3-1. Example 1

3-2. Example 2 (Modified Example of Example 1)

3-3. Example 3 (Modified Example of Example 2)

3-4. Example 4 (Modified Example of Example 3; Modified Example of Wiring Structure of Signal Line in Square Array)

4. Electronic Apparatus

5. Modified Example

<General Description of Display Device and Electronic Apparatus of the Present Disclosure>

In a display device and an electronic apparatus of the present disclosure, the drivers of a plurality of system can have a configuration in which video signals are supplied to a plurality of adjacent signal lines at the same timing. Since the supply timings of the video signals to the plurality of adjacent signal lines are the same, no coupling occurs even in a case where a parasitic capacitor exists between the plurality of adjacent signal lines. With this configuration, deterioration of uniformity caused by coupling can be prevented even in a case of providing no shield portion between the plurality of adjacent signal lines.

In the display device and the electronic apparatus of the present disclosure including the above-described preferable configuration, the video signal supply unit can have a configuration in which a plurality of signal lines each provided per pixel column of the pixel array unit is set as a unit, and video signals are supplied to the plurality of signal lines set as the unit in a time sharing manner. A video signal supply system of such a video signal supply unit is a so-called selector driving system. The selector driving system may also be referred to as a time-sharing driving system. In selector driving, a switch is provided between one driver and the plurality of signal lines set as the unit, and driving to sequentially charge/discharge the plurality of signal lines is performed by the one driver by sequentially turn on/off the switch. Furthermore, the video signals are collectively written in pixels in synchronization with a write scanning signal after video signals are supplied to respective signal lines. By adopting such a selector driving system, the number of drivers constituting the video signal supply unit can be reduced, and also a frame of a display panel can be formed narrower.

Moreover, in the display device and the electronic apparatus of the present disclosure including the above-described preferable configuration, it is possible to provide a configuration in which two signal lines provided close to each other are set as the plurality of adjacent signal lines, and two pixel columns corresponding to these two signal lines are arranged outside the two signal lines. In other words, it is possible to provide a configuration in which the two signal lines are wired between the two pixel columns along the pixel columns. Additionally, the adjacent pixels interposing the two signal lines between the two pixel column can have a configuration of being arranged symmetrically with respect to an axial line passing at a center between the two signal lines. A pixel includes a writing transistor to write, in the pixel, a video signal to be supplied to a signal line. At this point, a gate electrode of each of the writing transistors of the adjacent pixels interposing the two signal lines can have a configuration including a common electrode.

Furthermore, in the display device and the electronic apparatus of the present disclosure including the above-described preferable configuration, in a case where two adjacent pixel columns are set as a unit, a pixel can have a configuration including: sub-pixels belonging to one pair of two pixel columns and having relatively high spectral luminous efficacy; and sub-pixels belonging to the other pair of two pixel columns adjacent to the one pair of two pixel columns and having relatively low spectral luminous efficacy. At this point, it is preferable to have a configuration in which a shield portion is provided between a set of signal lines of the one pair of two pixel columns and a set of signal lines of the other pair of two pixel columns. Additionally, the video signal supply unit can have a configuration in which, in a case of stepwisely supplying video signals in a unit of two adjacent signal lines in a time sharing manner, the video signal supply unit supplies the video signals to signal lines connected to the sub-pixels having relatively low spectral luminous efficacy in the initial step, and supplies the video signals to signal lines connected to the sub-pixels having relatively high spectral luminous efficacy in second and subsequent steps.

Furthermore, in the display device and the electronic apparatus of the present disclosure including the above-described preferable configuration, a pixel can have a configuration including four sub-pixels of a red sub-pixel, a green sub-pixel, a blue sub-pixel, and a white sub-pixel. At this point, the video signal supply unit preferably has a configuration in which: video signals are supplied to signal lines connected to the red sub-pixel and sub-pixel of the blue sub-pixel in the initial step; and video signals are supplied to signal lines connected to the green sub-pixel and the white sub-pixel in the second and subsequent steps. Furthermore, the adjacent pixels between the two pixel columns corresponding to the two signal lines can have a configuration including: a pair of the red sub-pixel and the blue sub-pixel; and a pair of the green sub-pixel and the white sub-pixel.

<Display Device to Which Technology of the Present Disclosure is Applied>

An active matrix display device is exemplified as a display device to which the technology of the present disclosure is applied. An active matrix display device is a display device in which current flowing in a light emitting portion (light emitting element/electro-optical element) is controlled by an active element provided inside a pixel circuit same as the light emitting portion is provided, for example, by an insulated gate field effect transistor. Typically, a thin film transistor (TFT) can be exemplified as the insulated gate field effect transistor.

In the following, a description will be provided by exemplifying a case of an organic EL display device including an organic EL element in which a light emitting portion (light emitting element) of a pixel circuit utilizes, for example, an electro luminescence (EL) of an organic material and a phenomenon of emitting light by applying an electric field to an organic thin film is used. The organic EL element is a current-driven light emitting element in which light emission luminance is changed in accordance with a current value flowing in a device.

[System Configuration]

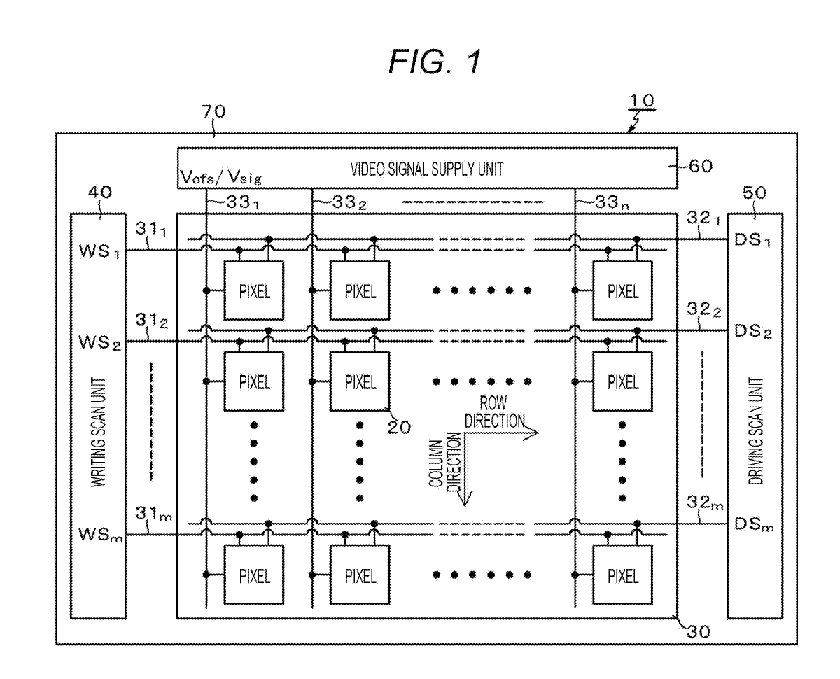

FIG. 1 is a system configuration diagram schematically illustrating a basic configuration of an active matrix organic EL display device. In the following, a “pixel circuit” including a light emitting portion (light emitting element) may be simply referred to as a “pixel”.

As illustrated in FIG. 1, an organic EL display device 10 according to the present example includes: a pixel array unit 30 in which a plurality of pixels 20 each including an organic EL element is two-dimensionally arrayed in a matrix form (two-dimensional matrix form) ; and a drive unit arranged in a periphery of the pixel array unit 30 and adapted to drive each of the pixels 20. The drive unit includes, for example, a writing scan unit 40, a driving scan unit 50, a video signal supply unit 60, and the like.

In the present example, the writing scan unit 40, driving scan unit 50, and video signal supply unit 60 are mounted as a peripheral circuit of the pixel array unit 30 on a substrate same as the pixel array unit 30, that is, on a display panel 70. However, it is also possible to adopt a configuration in which some or all of the writing scan unit 40, driving scan unit 50, and video signal supply unit 60 are provided outside the display panel 70. Additionally, while provided is a configuration in which the writing scan unit 40 and the driving scan unit 50 are arranged on one side of the pixel array unit 30, it is also possible to adopt a configuration in which these units are arranged on both sides interposing the pixel array unit 30. As the substrate of the display panel 70, an insulation substrate such as a glass substrate can be used or a semiconductor substrate such as a silicon substrate can also be used.

The organic EL display device 10 is a display device supporting color display. In this case, one pixel (unit pixel/pixel) serving as a unit to forma color image includes a plurality of sub-pixels. In this case, each of the sub-pixels corresponds to the pixel 20 in FIG. 1. More specifically, in the display device supporting color display, one pixel includes, for example, three sub-pixels including a sub-pixel to emit red (R) light, a sub-pixel to emit green (G) light, and a sub-pixel to emit blue (B) light.

However, one pixel is not limited to a combination of sub-pixels of three primary colors of RGB, and one pixel can also be formed by further adding a sub-pixel of one color or a plurality of colors to the sub-pixels of the three primary colors. More specifically, for example, a sub-pixel to emit white (W) light can be added to form one pixel in order to improve luminance, or at least one sub-pixel to emit complementary color light can also be added to form one pixel in order to broaden a color reproduction range.

In the pixel array unit 30, a scanning line 31 (each of 31₁ to 31ₘ) and a driving line 32 (each of 32₁ to 32ₘ) are wired per pixel row in a row direction (array direction of pixels of a pixel row) in an array of the pixels 20 including m rows and n columns. Furthermore, a signal line 33 (each of 33₁ to 33ₙ) is wired per pixel column in a column direction (array direction of pixels of a pixel column) in the array of the pixels 20 including m rows and n columns.

The scanning lines 31₁ to 31ₘ are respectively connected to output terminals of corresponding rows in the writing scan unit 40. The driving lines 32₁ to 32ₘ are respectively connected to output terminals of corresponding rows in the driving scan unit 50. The signal lines 33₁ to 33ₙ are respectively connected to output terminals of corresponding columns in the video signal supply unit 60.

The writing scan unit 40 includes a shift register circuit and the like. The writing scan unit 40 sequentially supplies a write scanning signal WS (each of WS₁ to WSₘ) to the scanning line 31 (each of 31₁ to 31ₘ) at the time of writing a signal voltage of a video signal in each of the pixels 20 of the pixel array unit 30. Consequently, so-called line sequential scanning to sequentially scan each of the pixels 20 of the pixel array unit 30 in a row unit is performed.

The driving scan unit 50 includes a shift register circuit and the like in a manner similar to the writing scan unit 40. The driving scan unit 50 supplies a light emission control signal DS (each of DS₁ to DSₘ) to the driving line 32 (each of 32₁ to 32ₘ) in synchronization with the line sequential scanning performed by the writing scan unit 40, thereby controlling light emission/non-emission (extinction) in the pixels 20.

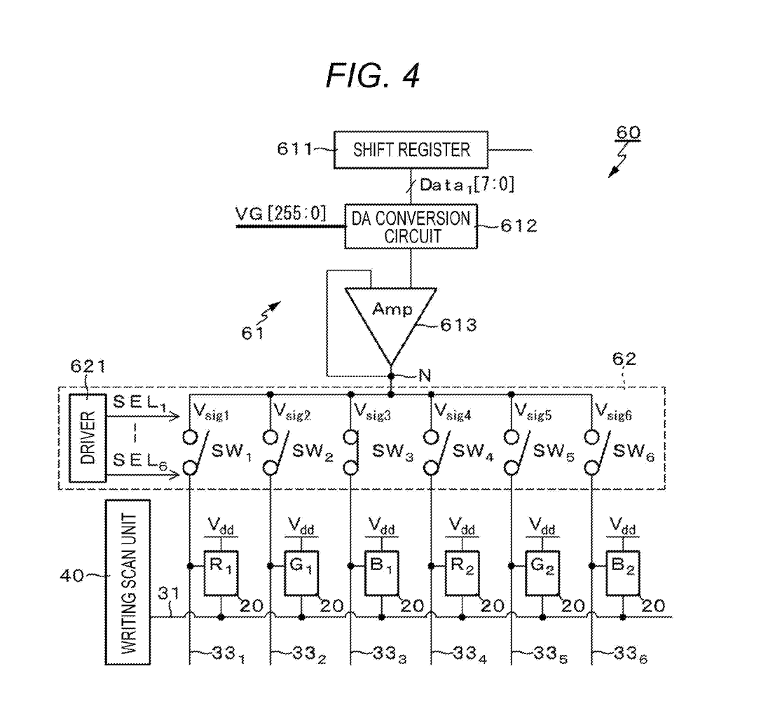

The video signal supply unit 60 selectively supplies a signal voltage V_{sig} of a video signal (hereinafter may be simply referred to as a “signal voltage”) corresponding to luminance information and a reference voltage V_{ofs} to the signal lines 33₁ to 33ₙ. Here, the reference voltage V_{ofs} corresponds to a voltage to be a reference of the signal voltage V_{sig} of the video signal (for example, a voltage corresponding to a black level of a video signal) and is used in threshold correction described later. The video signal supply unit 60 adopts a known selector driving system in order to reduce the number of data drivers 61 (refer to FIG. 4) and narrow a frame of the display panel 70. The selector driving system will be described in detail later.

The signal voltage V_{sig}/reference voltage V_{ofs} alternatively supplied from the video signal supply unit 60 to each of the signal lines 33₁ to 33ₙ is written in each of the pixels 20 of the pixel array unit 30 per pixel row selected by scanning performed by the writing scan unit 40. In other words, the organic EL display device 10 according to the present example adopts a mode in which the signal voltage V_{sig} supplied to each of the signal lines 33₁ to 33ₙ is written in each of the pixels 20 of the pixel array unit 30 row by row (line by line).

[Pixel Circuit]

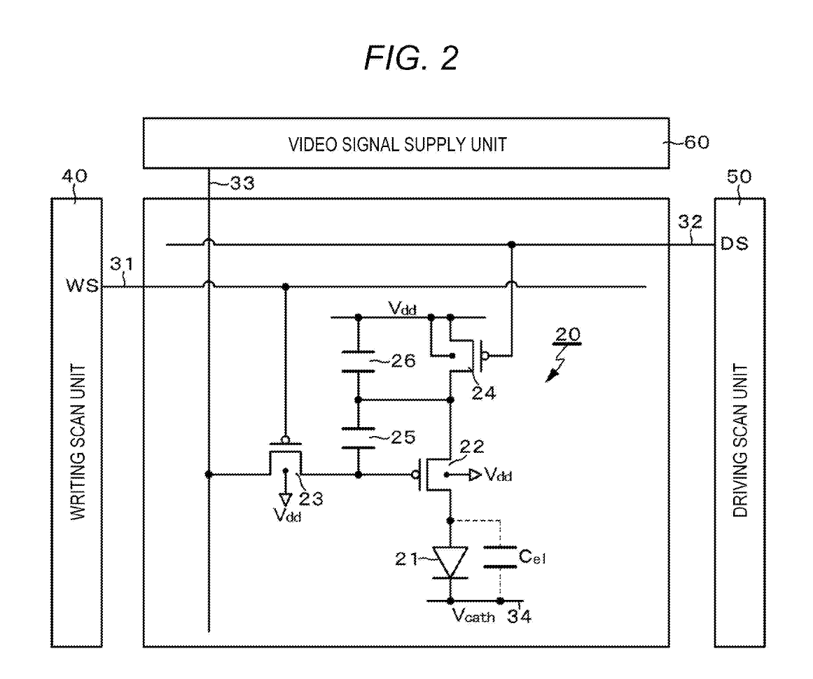

FIG. 2 is a circuit diagram illustrating an exemplary circuit configuration of a pixel (pixel circuit) 20. As illustrated in FIG. 2, the pixel 20 includes: an organic EL element 21; and a drive circuit to drive the organic EL element 21 by applying current to the organic EL element 21. The organic EL element 21 has a cathode electrode connected to a common power supply line 34 wired in common for all of the pixels 20.

The drive circuit to drive the organic EL element 21 includes a driving transistor 22, a writing transistor (sampling transistor) 23, a light emission control transistor 24, a storage capacitor 25, and an auxiliary capacitor 26. Meanwhile, in the present example, adopted is a configuration in which a P-channel transistor is used as the driving transistor 22, assuming that the pixel 20 is formed on a semiconductor substrate such as a silicon substrate.

Additionally, in the present example, the writing transistor 23 and the light emission control transistor 24 also adopt a configuration in which a P-channel transistor is used in a manner similar to the driving transistor 22. Therefore, the driving transistor 22, writing transistor 23, and light emission control transistor 24 each have four terminals including a source, a gate, a drain, and a back gate instead of three terminals including a source, a gate, and a drain but have. A power supply voltage V_{dd} is applied to the back gate.

However, since the writing transistor 23 and the light emission control transistor 24 are switching transistors functioning as switch elements, the transistors are not limited to be the P-channel transistors. Therefore, the writing transistor 23 and the light emission control transistor 24 may be N-channel transistors or may also have a configuration in which a P-channel and an N-channel are combined.

In the pixel 20 having the above configuration, the writing transistor 23 samples the signal voltage V_{sig} supplied to the signal line 33 from the video signal supply unit 60, thereby writing the signal voltage in the pixel 20 by sampling the same. The light emission control transistor 24 is connected between a node of the power supply voltage V_{dd} and a source electrode of the driving transistor 22, and controls light emission/non-emission in the organic EL element 21 under driving by the light emission control signal DS.

The storage capacitor 25 is connected between a gate electrode and a source electrode of the driving transistor 22. The storage capacitor 25 stores the signal voltage V_{sig} written by the writing transistor 23. The driving transistor 22 drives the organic EL element 21 by applying, to the organic EL element 21, drive current corresponding to the stored voltage in the storage capacitor 25.

The auxiliary capacitor 26 is connected between the source electrode of the driving transistor 22 and a node of a fixed potential, for example, the node of the power supply voltage V_{dd}. The auxiliary capacitor 26 suppresses fluctuation of a source potential of the driving transistor 22 at the time of writing the signal voltage V_{sig} and also provides an effect of bringing a gate-source voltage V_{gs} of the driving transistor 22 to a threshold voltage Vₜₕ of the driving transistor 22.

[Basic Circuit Operation]

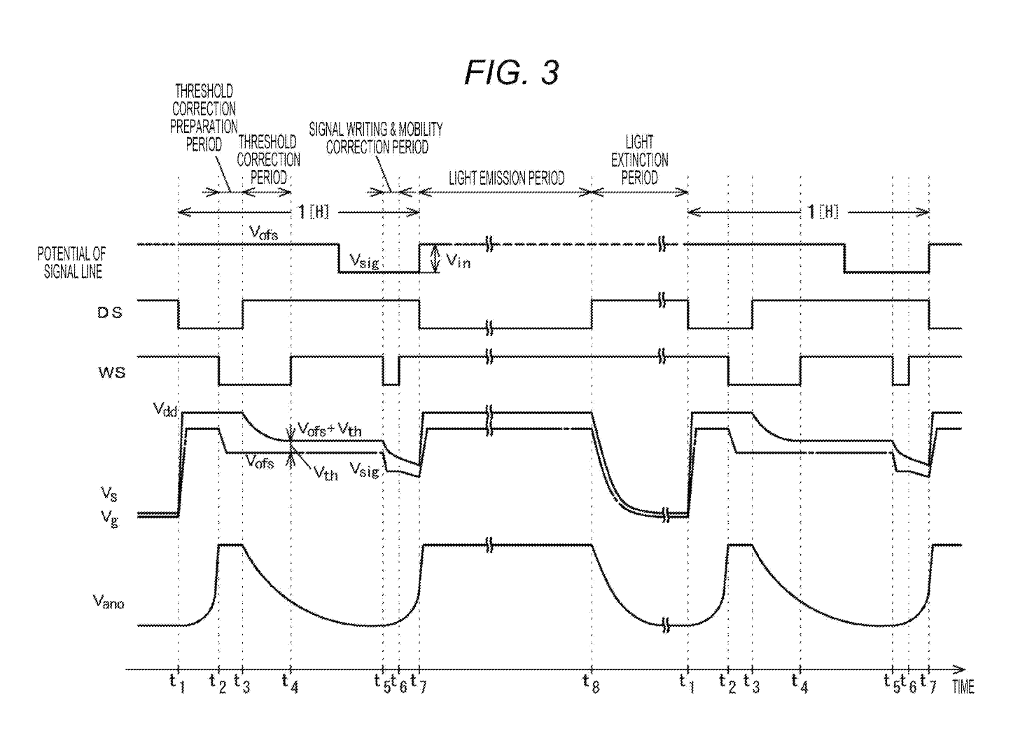

Subsequently, basic circuit operation of the active matrix organic EL display device 10 will be described with reference to a timing waveform chart in FIG. 3.

In the timing waveform chart in FIG. 3, illustrated are respective change states of the potential V_{ofs}/V_{sig} of the signal line 33, the light emission control signal DS, the write scanning signal WS, a source potential Vₛ of the driving transistor 22, a gate potential V_{g}, and an anode potential Vₐₙₒ of the organic EL element 21. In the timing waveform chart in FIG. 3, a waveform of the gate potential V_{g} is indicated by a dot-and-dash line.

Meanwhile, since the writing transistor 23 and the light emission control transistor 24 are the P-channel transistors, a low potential state becomes an active state and a high potential state becomes an inactive state in the write scanning signal WS and the light emission control signal DS. Additionally, the writing transistor 23 and the light emission control transistor 24 are brought into a conductive state in a case where the write scanning signal WS and the light emission control signal DS are in the active state, and these transistors are brought into a non-conductive state in a case where these signals are in the inactive state.

The light emission control signal DS becomes the inactive state and the light emission control transistor 24 is brought into the non-conductive state at time t₈, thereby discharging electric charge stored in the storage capacitor 25 through the driving transistor 22. Then, in a case where the gate-source voltage V_{gs} of the driving transistor 22 becomes the threshold voltage Vₜₕ of the driving transistor 22 or less, the driving transistor 22 is cut off.

In a case where the driving transistor 22 is cut off, a path of current supply to the organic EL element 21 is blocked, and therefore, the anode potential Vₐₙₒ of the organic EL element 21 is gradually decreased. Eventually, in a case where the anode potential Vₐₙₒ of the organic EL element 21 becomes a threshold voltage Vₜₕₑₗ of the organic EL element 21 or less, the organic EL element 21 is brought into a complete light extinction state. After that, the light emission control signal DS becomes the active state and the light emission control transistor 24 is brought into the conductive state at time t₁, thereby entering a 1H period (H represents one horizontal period) . Consequently, a period t₈-t₁ becomes a light extinction period.

The power supply voltage V_{dd} is written in the source electrode of the driving transistor 22 by the light emission control transistor 24 being brought into the conductive state. Then, the gate potential V_{g} is also increased together with increase of the source potential Vₛ of the driving transistor 22. After that, the write scanning signal WS becomes the active state at time t₂, thereby bringing the writing transistor 23 into the conductive state to perform sampling of the potential of the signal line 33. At this point, the reference voltage V_{ofs} is supplied to the signal line 33. Therefore, the reference voltage V_{ofs} is written in the gate electrode of the driving transistor 22 by sampling performed by the writing transistor 23. Consequently, voltage of (V_{dd}-V_{ofs}) is stored in the storage capacitor 25.

Here, to perform threshold correcting operation (threshold correction processing) described later, it is necessary to preliminarily set the gate-source voltage V_{gs} of the driving transistor 22 to a voltage exceeding the threshold voltage Vₜₕ of the driving transistor 22. Therefore, each voltage value is set to satisfy a relation of |V_{gs}|=|V_{dd}−V_{ofs}|>|Vₜₕ|.

Thus, initializing operation to set the gate potential V_{g} of the driving transistor 22 to the reference voltage V_{ofs} is preparing operation (preparation for threshold correction) before performing next threshold correcting operation. Therefore, the reference voltage V_{ofs} corresponds to an initialization voltage of the gate potential V_{g} of the driving transistor 22.

Next, when the light emission control signal DS becomes the inactive state and the light emission control transistor 24 is brought in the non-conduction state at time t₃, the source potential Vₛ of the driving transistor 22 becomes a floating state. Then, the threshold correcting operation is started in a state that the gate potential V_{g} of the driving transistor 22 is kept at the reference voltage V_{ofs}. In other words, decrease (drop) of the source potential Vₛ of the driving transistor 22 is started toward a potential (V_{ofs}-Vₜₕ) in which the threshold voltage Vₜₕ is subtracted from the gate potential V_{g} of the driving transistor 22.

Thus, the threshold correcting operation is the operation in which the initialization voltage V_{ofs} of the gate potential V_{g} of the driving transistor 22 is set as a reference and the source potential Vₛ of the driving transistor 22 is changed toward the potential (V_{ofs}-Vₜₕ) in which the threshold voltage Vₜₕ is subtracted from the initialization voltage V_{ofs}. With progress of the threshold correcting operation, the gate-source voltage V_{gs} of the driving transistor 22 eventually converges to the threshold voltage Vₜₕ of the driving transistor 22. The voltage corresponding to the threshold voltage Vₜₕ is stored in the storage capacitor 25. At this point, the source potential Vₛ of the driving transistor 22 is Vₛ=V_{ofs}-Vₜₕ.

Then, when the write scanning signal WS becomes the inactive state and the writing transistor 23 is brought into the non-conductive state at time t₄, a threshold correction period ends. After that, the signal voltage V_{sig} of the video signal is output from the video signal supply unit 60 to the signal line 33, and the potential of the signal line 33 is switched from the reference voltage V_{ofs} to the signal voltage V_{sig} .

Next, the write scanning signal WS becomes the active state at time t₅, thereby bringing the writing transistor 23 into the conductive state to perform writing the signal voltage V_{sig} in the pixel 20 by sampling the same. Since the signal voltage V_{sig} is written by the writing transistor 23, the gate potential V_{g} of the driving transistor 22 becomes the signal voltage V_{sig}.

At the time of writing the signal voltage V_{sig} of this video signal, the auxiliary capacitor 26 connected between the source electrode of the driving transistor 22 and the node of the power supply voltage V_{dd} functions to suppress fluctuation of the source potential Vₛ of the driving transistor 22. Then, when the driving transistor 22 is driven by the signal voltage V_{sig} of the video signal, the threshold voltage Vₜₕ of the driving transistor 22 is canceled by a voltage corresponding to the threshold voltage Vₜₕ stored in the storage capacitor 25.

At this point, the gate-source voltage V_{gs} of the driving transistor 22 is increased in accordance with the signal voltage V_{sig}, but the source potential Vₛ of the driving transistor 22 is still in the floating state. Therefore, charged electricity in the storage capacitor 25 is discharged in accordance with a characteristic of the driving transistor 22. Additionally, charging an equivalent capacitor Cₑₗ of the organic EL element 21 is started by current flowing in the driving transistor 22.

Since the equivalent capacitor Cₑₗ of the organic EL element 21 is charged, the source potential Vₛ of the driving transistor 22 is gradually decreased with lapse of time. At this point, variation of the threshold voltage Vₜₕ of the driving transistor 22 in each of the pixels is already canceled, and drain-source current I_{ds} of the driving transistor 22 is dependent on mobility p of the driving transistor 22. Note that the mobility p of the driving transistor 22 is mobility of a semiconductor thin film constituting a channel of the driving transistor 22.

Here, a decreased amount of the source potential Vₛ of the driving transistor 22 acts so as to discharge the charged electricity in the storage capacitor 25. In other words, negative feedback is applied to the storage capacitor 25 by the decreased amount (changed amount) of the source potential Vₛ of the driving transistor 22. Therefore, the decreased amount of the source potential Vₛ of the driving transistor 22 is to be a feedback amount of the negative feedback.

Thus, dependency on the mobility p of the drain-source current I_{ds} flowing in the driving transistor 22 can be canceled by applying the negative feedback to the storage capacitor 25 by the feedback amount according to the current I_{ds} flowing in the driving transistor 22. Such canceling operation (cancel processing) corresponds to mobility correcting operation (mobility correction processing) to correct variation of the mobility p of the driving transistor 22 in each of the pixels.

More specifically, the larger the drain-source current I_{ds} is, the larger a signal amplitude Vᵢₙ (=V_{sig}−V_{ofs}) of the video signal to be written in the gate electrode of the driving transistor 22 is, and therefore, an absolute value of the feedback amount of the negative feedback also becomes large.

Therefore, mobility correction processing is performed in accordance with the signal amplitude Vᵢₙ of the video signal, namely, a light emission luminance level. Additionally, in a case where the signal amplitude Vᵢₙ of the video signal is constant, the larger the mobility p of the driving transistor 22 is, the larger the absolute value of the feedback amount of the negative feedback is, and therefore, variation of the mobility p in each of the pixels can be eliminated.

The write scanning signal WS becomes the inactive state and the writing transistor 23 is brought into the non-conductive state at time t₆, thereby finishing a period of signal writing and mobility correction. The light emission control signal DS becomes the active state at the time t₇ after the mobility correction is performed, thereby bringing the light emission control transistor 24 into the conductive state. Consequently, current is supplied from the node of the power supply voltage V_{dd} to the driving transistor 22 through the light emission control transistor 24.

At this point, since the writing transistor 23 is in the non-conductive state, the gate electrode of the driving transistor 22 is electrically separated from the signal line 33 and being in the floating state. Here, when the gate electrode of the driving transistor 22 is in the floating state, the gate potential V_{g} also fluctuates together with fluctuation of the source potential Vₛ of the driving transistor 22 because the storage capacitor 25 is connected between the gate and the source of the driving transistor 22.

In other words, the source potential Vₛ and the gate potential V_{g} of the driving transistor 22 are increased while keeping the gate-source voltage V_{g}, stored in the storage capacitor 25. Additionally, the source potential Vₛ of the driving transistor 22 is increased up to a light emitting voltage V_{oled} of the organic EL element 21 according to saturation current of the transistor.

Thus, operation in which the gate potential V_{g} of the driving transistor 22 fluctuates together with fluctuation of the source potential Vₛ is bootstrap operation. In other words, the bootstrap operation is the operation in which the gate potential V_{g} and the source potential Vₛ of the driving transistor 22 fluctuate while keeping the gate-source voltage V_{g}, stored in the storage capacitor 25, namely, voltage between both terminals of the storage capacitor 25.

Then, when the drain-source current I_{ds} of the driving transistor 22 starts flowing in the organic EL element 21, the anode potential Vₐₙₒ of the organic EL element 21 is increased according to the current I_{ds}. Eventually, in a case where the anode potential Vₐₙₒ of the organic EL element 21 exceeds the threshold voltage Vₜₕₑₗ of the organic EL element 21, drive current starts flowing in the organic EL element 21, and therefore, the organic EL element 21 starts emitting light.

However, the above-described threshold correction and mobility correction are not indispensable operation in the technology of the present disclosure. Additionally, as for the above-described various kinds of correction, light emission, and the like, operation and timings are not limited to those described above.

[Selector Driving System]

The selector driving system adopted by the video signal supply unit 60 as a driving system is the driving system in which the signal lines 33₁ to 33ₙ are allocated as a unit (pair) of a plurality of signal lines to one output of the data driver 61 (refer to FIG. 4) , and signal voltages V_{sig} output in time series from the data driver 61 are distributed in a time sharing manner (like time sharing) to the plurality of unit signal lines set as the unit. In the following, a case in which a signal voltage V_{sig} of a video signal is supplied to each of the signal lines 33₁ to 33ₙ will be described for easy understanding. By adopting the selector driving system, the frame of the display panel 70 can be formed narrower because the number of data drivers 61 can be more significantly reduced than a case of providing the data driver 61 in each of the signal lines 33₁ to 33ₙ.

(Video Signal Supply Unit According to Example in Related Art)

Here, a configuration of the video signal supply unit 60 according to an example in the related art will be described using FIG. 4. FIG. 4 is a block diagram illustrating an exemplary configuration of the video signal supply unit 60 according to the example in the related art. Here, illustrated is a case of a stripe array in which one pixel to be a unit of a color image includes three sub-pixels of RGB and the three sub-pixels RGB are arrayed per pixel column. Also, the number of time sharing (the number of signal lines set as the unit) x is set to 6 (x=6).

As illustrated in FIG. 4, the video signal supply unit 60 includes a data driver 61 and a selector circuit 62. The data driver 61 includes, for example, a shift register 611, a digital-analog (DA) conversion circuit 612, an amplifier 613, and the like, and one data driver is provided for six adjacent signal lines, namely, the signal lines 33₁ to 33₆ in the illustrated example. In other words, in the present example case, while the six signal lines are as a unit, a plurality of data drivers 61 is provided. The selector circuit 62 includes: switches SW₁ to SW₆ connected between an output node (output terminal) N of the data driver 61 and one end of each of the six signal lines 33₁ to 33₆; and a driver 621 to drive the switches SW₁ to SW₆. The driver 621 sequentially outputs selection signals SEL₁ to SEL₆ to sequentially drive the switches SW₁ to SW₆ in a time sharing manner.

According to the video signal supply unit 60 according to the above-described example in the related art, the video signals are sequentially output from the data driver 61 in a time sharing manner to the six signal lines 33₁ to 33₆ set as a unit of selector driving (time sharing driving). Therefore, supply timings (writing timings) of the video signals to adjacent signal lines are different in the six signal lines 33₁ to 33₆. In other words, when a video signal is written in one of the adjacent signal lines, the other signal line is in the electrically floating state.

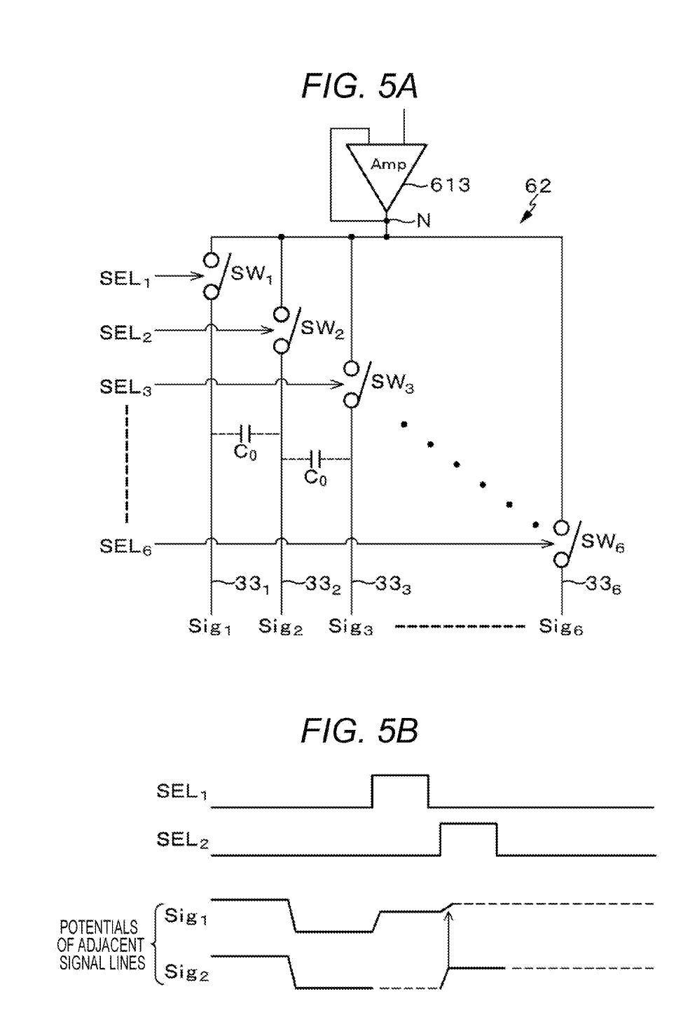

On the other hand, a parasitic capacitor Cₒ normally exists between adjacent signal lines (refer to FIG. 5A). Furthermore, in an example of FIG. 5A, in a case where supply timings of video signals to adjacent signal lines, for example, a signal line 33₁ and a signal line 33₂, a signal line 33₂ and a signal lines 33₃, . . . are different, coupling (capacitive coupling) occurs via the parasitic capacitor C₀ as illustrated in FIG. 5B due to existence of the parasitic capacitor C₀ between the adjacent signal lines. Then, even in a case where video signals having the same level are written in the adjacent signal lines, a difference of a signal level at the time of writing the video signals in the pixels 20 is caused between adjacent pixels 20 and 20.

As a result, drive current of the organic EL element 21 becomes different between the adjacent pixels 20 and 20, and therefore, noise formed along a pixel column, namely, vertical stripe-like noise is generated and recognized as a uniformity defect. In a case of adopting a configuration of providing a shield portion between adjacent pixel columns (between adjacent signal lines) in order to improve such a uniformity defect caused by the capacitive coupling, the shield portion is provided per pixel column, and therefore, not only miniaturization of a pixel unit but also improvement of definition of the display device are hindered.

<One Embodiment of Present Disclosure>

One embodiment of the present disclosure is characterized in that, in an EL display device 10 including a video signal supply unit 60 that adopts a selector driving system, the video signal supply unit 60 includes drivers of a plurality of systems provided in a manner corresponding to a plurality of adjacent signal lines. With this configuration, video signals can be supplied from each of the drivers of the plurality of systems at the same timing to a plurality of adjacent signal lines such as a signal line 33₁ and a signal line 33₂, a signal line 33₃ and a signal line 33₄, and a signal lines 33₅ and a signal line 33₆ in an example of FIG. 5A.

The “adjacent signal lines” in the present embodiment indicates a fact that there is no other wire existing between adjacent signal lines. Furthermore, since supply timings of the video signals to the adjacent signal lines are the same, no coupling occurs even in a case where a parasitic capacitor Cₒ exists between the adjacent signal lines. Consequently, there is no need to provide a shield portion between adjacent signal lines, for example, between the signal line 33₁ and the signal line 33₂, between the signal line 33₃ and the signal line 33₄, and between the signal line 33₃ and the signal line 33₆ in the example of FIG. 5A.

However, since the supply timings of video signals are different between the signal line 33₂ and the signal line 33₃ and between the signal line 33₄ and the signal line 33₅, it is necessary to provide shield portions between the signal line 33₂ and the signal line 33₃ and between the signal line 33₄ and the signal lines 33₅, respectively. However, since the shield portion can be omitted while two adjacent signal lines (pixel columns) are set as a unit, not only miniaturization of a pixel unit but also definition of the display device can be improved. Additionally, deterioration of uniformity caused by capacitive coupling can be prevented.

Here, the “plurality of adjacent signal lines” is set as the “adjacent two signal lines” but not limited to the two signal lines.

In the following, specific examples of the present embodiment will be described.

### EXAMPLE 1

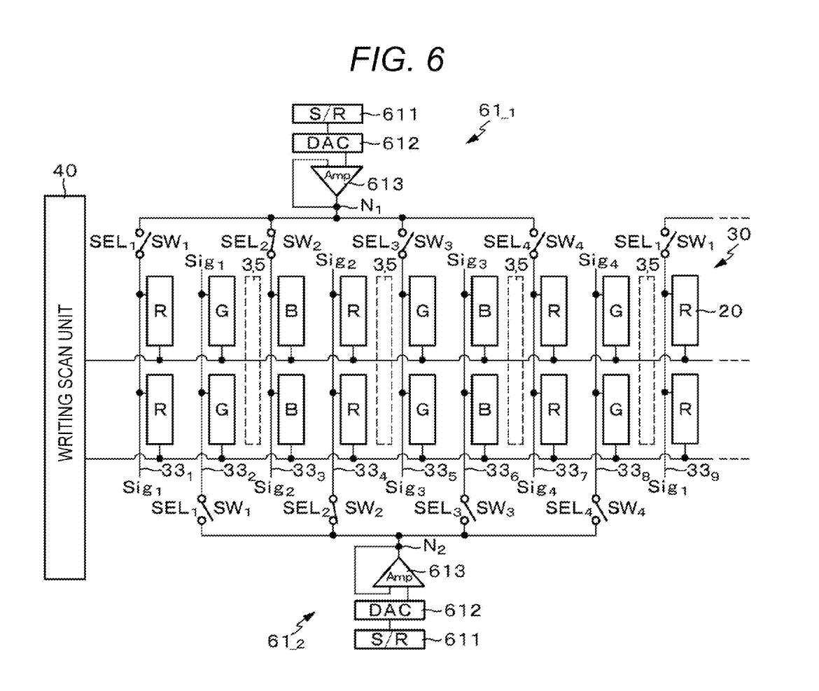

FIG. 6 is a block diagram illustrating an exemplary configuration of the video signal supply unit 60 according to Example 1. Example 1 exemplifies a case of a stripe array in which one pixel to be a unit of a color image includes three sub-pixels of RGB, and each of the three sub-pixels RGB is arrayed in a unit of pixel column. Furthermore, in the Example 1, the number of time sharing (the number of signal lines set as a unit) x is set to 8 (x=8). With this configuration, the data driver is provided while the eight signal lines are set as a unit.

However, while one data driver is provided while the eight signal lines are set as a unit in the prior art, the Example 1 adopts a configuration in which data drivers of two systems are provided in every eight signal lines. Note that the number of signal lines set as a unit is not limited to eight although it is specified here to be eight, and as for the data drivers, the number of systems is also not limited to the two systems and may also be three of more systems. In FIG. 6, the eight signal lines 33₁ to 33₈ in the first to eighth columns are illustrated to simplify the drawing.

As illustrated in FIG. 6, the video signal supply unit 60 according to the Example 1 has a configuration in which data drivers 61__{¹} and 61__{²} of two systems are provided in the eight signal lines 33₁ to 33₈, for example. The data drivers 61__{¹} and 61__{²} of the two systems are arranged upper and lower sides interposing a pixel array unit 30 in which pixels (sub-pixels) 20 are two-dimensionally arrayed in a matrix form. In FIG. 6, an array including two rows of pixels 20 is illustrated to simplify the drawing.

The data driver 61__{¹} arranged on the upper side of the pixel array unit 30 takes a role to supply video signals to the four signal lines 33₁, 33₃, 33₅, and 33₇ of odd-numbered columns out of the eight signal lines 33₁ to 33₈. The data driver 61__{²} arranged on the lower side of the pixel array unit 30 takes a role to supply video signals to the four signal lines 33₂, 33₄, 33₆, and 33₈ of even number column out of the eight signal lines 33₁ to 33₈.

In the data driver 61__{¹}, switches SW₁, SW₂, SW₃ and SW₄ are connected between an output node N₁ of an amplifier 613 and the four signal lines 33₁, 33₃, 33₃, and 33₇. Similarly, in the data driver 61__{²}, switches SW₁, SW₂, SW₃, and SW₄ are connected between an output node N₂ of an amplifier 613 and the four signal lines 33₂, 33₄, _{336,} and 33₈.

Furthermore, the switch SW₁ of the first column and the switch SW₁ of the second column are simultaneously driven by selection signals SEL₁, and the switch SW₂ of the third column and the switch SW₂ of the fourth column are simultaneously driven by selection signals SEL₂. Also, the switch SW₃ of the fifth column and the switch SW₃ of the sixth column are simultaneously driven by selection signals SEL₃, and the switch SW₄ of the seventh column and the switch SW₄ of the eighth column are simultaneously driven by selection signals SEL₄. With this configuration, video signals are supplied at the same timing from the data drivers 61__{¹}, 61__{²} of the two systems to the signal line 33₁ of the first column, the signal line 33₂ of the second column, the signal line 33₃ of the third column, the signal line 33₄ of the fourth column, the signal line 33₅ of the fifth column, the signal line 33₆ of the sixth column, the signal line 33₇ of the seventh column, and the signal line 33₈ of the eighth column.

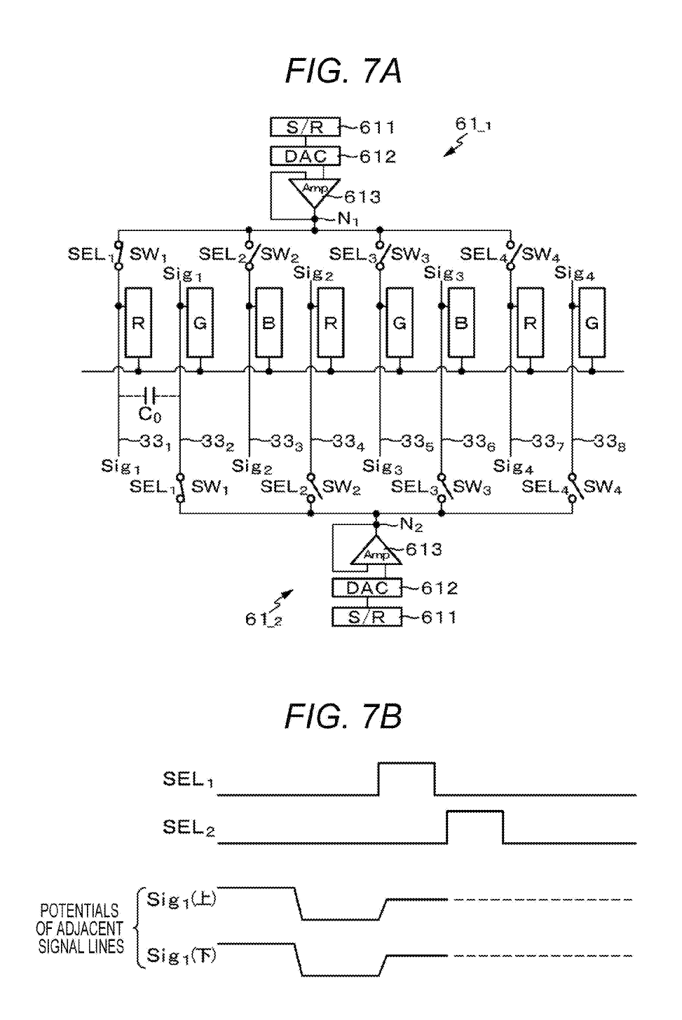

For example, as illustrated in FIG. 7A, the switch SW₁ of the first column and the switch SW₁ of the second column are simultaneously driven by the selection signals SEL₁. With this configuration, the switch SW₁ of the first column and the switch SW₁ of the second column are simultaneously brought into an ON (conductive) state, and therefore, a video signal output from the data driver 61__{¹} to the signal line 33₁ of the first column and a video signal output from the data driver 61__{²} to the signal line 33₂ of the second column are supplied at the same timing.

On the other hand, normally, a parasitic capacitor Cₒ exists between the signal lines 33₁ and 33₂ as illustrated in FIG. 7A. However, even in a case where the parasitic capacitor Cₒexists between the signal lines 33₁ and 33₂, the supply timings of the video signals to the adjacent signal lines 33₁ and 33₂ are the same and no floating state exists, and therefore, coupling via the parasitic capacitor Cₒ does not occur as illustrated in FIG. 7B. In FIG. 7B, Sig₁ (upper) of potentials Sig₁ of the adjacent signal lines represents a potential of the signal line 33₁ of the first column to which the video signal is supplied from the upper data driver 61__{¹} , and Sig₁ (lower) represents a potential of the signal line 33₂ of the second column to which the video signal is supplied from the data driver 61__{²}.

The similar description is applied in cases between the signal line 33₃ of the third column and the signal line 33₄ of the fourth column, between the signal line 33₅ of the fifth column and the signal line 33₆ of the sixth column, and between the signal line 33₇ of the seventh column and the signal line 33₈ of the eighth column. Thus, since coupling does not occur even in a case where a parasitic capacitor Cₒexists between adjacent signal lines, it is unnecessary to provide a shield portion between the adjacent signal lines. For example, in the example of FIG. 6, it is not necessary to provide shield portions between the signal line 33₁ and the signal line ³³₂, between the signal line 33₃ and the signal line 33₄, between the signal line 33₃ and the signal line 33₆, and between the signal line 33₇ and the signal line 33₈, respectively.

However, the supply timings of video signals are different between the signal line 33₂ and the signal line 33₃, between the signal line 33₄ and the signal line 33₅, and between the signal line 33₆ and the signal line 33₇. Therefore, it is preferable to have a configuration in which shield portions 35 are provided between the signal line 33₂ and the signal line 33₃, between the signal line 33₄ and the signal line 33₅, and between the signal line 33₆ and the signal line 33₇, respectively as illustrated in FIG. 6. Even in such a case, the shield portion 35 can be omitted while two adjacent signal lines (pixel columns) are set as a unit, not only more miniaturization of a pixel unit but also more improvement of definition of the display device can be achieved compared to a case of providing the shield portions 35 between the respective signal lines. Additionally, since occurrence of capacitive coupling can be suppressed, deterioration of uniformity caused by capacitive coupling can be prevented.

As for the shield portion 35, not particularly limited but, for example, it is also possible to use a known configuration such as a shield portion including: a shield wall in which a plurality of columnar conductors is arrayed apart from each other; and a shield wire that provides the shield wall with predetermined fixed potential.

In the Example 1, it is assumed to provide the configuration in which the data drivers 61__{¹} and 61__{²} of the two systems are arranged on both of the upper and lower sides interposing the pixel array unit 30 and video signals are supplied from the upper and lower sides while two signal lines are as the unit, but not limited thereto. In other words, it is also possible to adopt a configuration in which the data drivers 61__{¹} and 61__{²} of the two systems are collectively arranged on one of the upper and lower sides. Furthermore, in a case of using a semiconductor substrate such as a silicon substrate as a substrate of a display panel 70, it is also possible to provide a stacking structure in which the data drivers 61__{¹} and 61__{²} of the two systems are formed indifferent layers and the respective layers are stacked.

Additionally, in the Example 1, exemplified is the configuration in which the video signals are simultaneously supplied from the data drivers 61__{¹} and 61__{²} of the two systems while two adjacent signal lines are set as the unit, but the number of signal lines to be set as a unit is not limited to two and may also be three or more. In this case, drivers of a plurality of systems are also provided in a manner corresponding to the number of signal lines set as the unit. The similar is applied to Examples in the following.

### EXAMPLE 2

Example 2 is a modified example of the Example 1. In the Example 1, as illustrated in FIG. 6, the configuration in which one signal line is provided between adjacent pixel columns in the order of, for example, a signal line, a pixel column, a signal line, a pixel column, . . . in a row direction. On the other hand, in the Example 2, two signal lines are provided between adjacent pixel columns. More specifically, two adjacent signal lines are provided close to each other, and two pixel columns corresponding to these two signal lines are arranged outside the two signal lines.

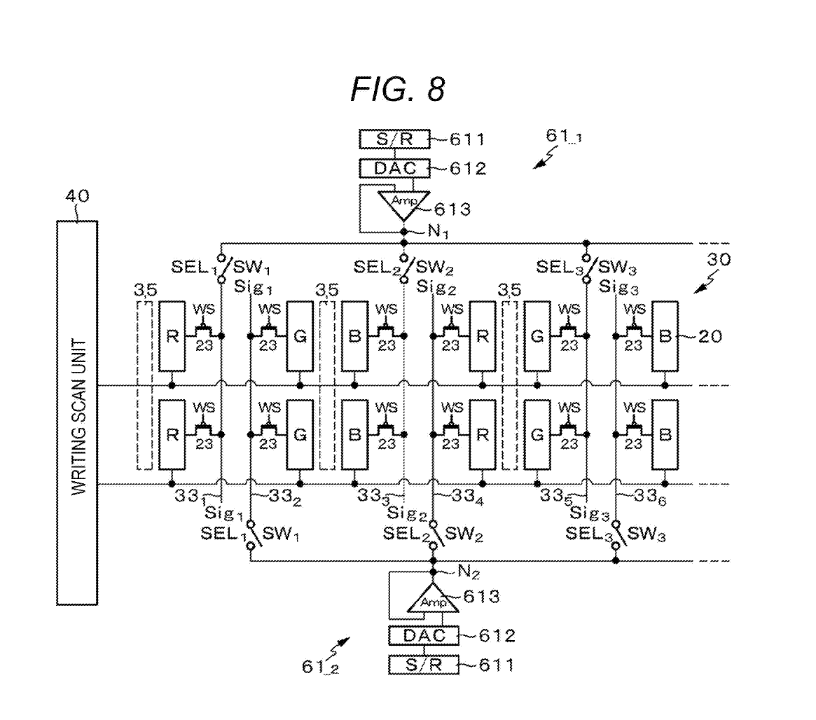

FIG. 8 is a block diagram illustrating an exemplary configuration of a video signal supply unit 60 according to the Example 2. As illustrated in FIG. 8, a signal line 33₁ of a first column and a signal line 33₂ of a second column are provided close to each other, and a pixel column of R and a pixel column of G corresponding to these signal lines 33₁ and 33₂ are arranged outside the signal lines 33₁ and 33₂. Furthermore, a signal line 33₃ of a third column and a signal line 33₄ of a fourth column are provided close to each other, and a pixel column of B and a pixel column of R corresponding to these signal lines 33₃, 33₄ are arranged outside the signal lines 33₃ and 33₄. In the following, the similar arrangement is repeated.

Video signals are supplied to the signal line 33₁ of the first column, the signal line 33₂ in the second column, the signal line 33₃ of the third column, the signal line 33₄ of the fourth column, . . . at the same timing from the data drivers 61__{¹}, 61__{²} of the two systems. With this configuration, coupling does not occur, and therefore, the signal line 33₁ of the first column and the signal line 33₂ of the second column, the signal line 33₃ of the third column and the signal line 33₄ of the fourth column, . . . can be arranged close to each other. However, the supply timings of the video signals are different between the signal line 33₂ of the second column and the signal line 33₃ of the third column and between the signal line 33₄ of the fourth column and the signal lines 33₅ of the fifth column. Therefore, as illustrated in FIG. 8, shield portions 35 are provided between a pixel column of G in a second eye column and a pixel column of B in the third column, between a pixel column of R in the fourth column and a pixel column of G in the fifth row, . . . , respectively.

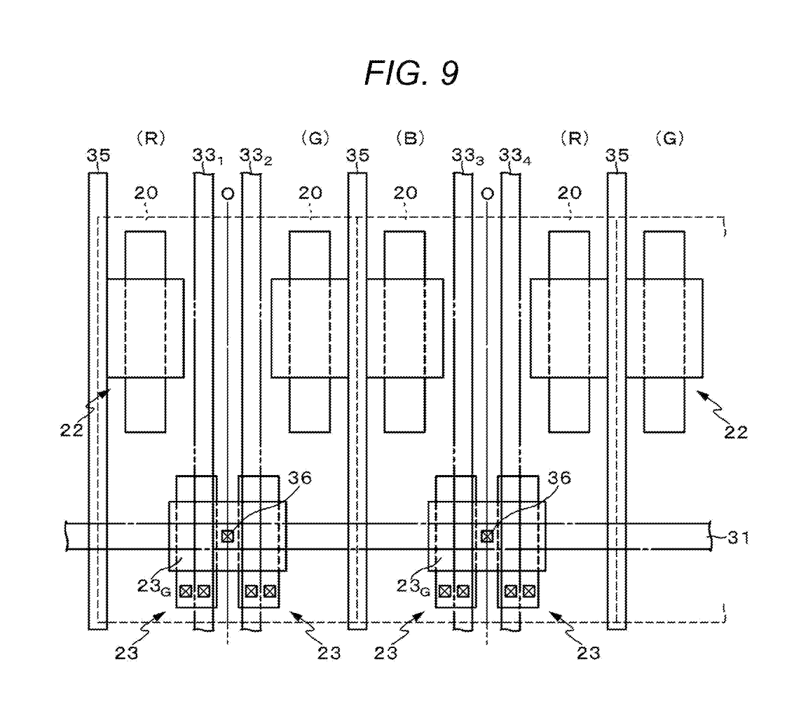

FIG. 9 is a plan pattern diagram schematically illustrating exemplary arrangement of constituent elements of pixels 20 according to the Example 2. In FIG. 9, only the driving transistor 22 and the writing transistor 23 are illustrated out of the constituent elements of the pixel 20 illustrated in FIG. 2. Here, the signal line 33₁ of the first column and the signal line 33₂ of the second column, and the pixel column of R in the first column and the pixel column of G in the second column will be described as representatives of two signal lines provided close to each other and two pixel columns arranged outside thereof.

As illustrated in FIG. 9, the adjacent pixels 20 interposing the two signal lines 33₁ and 33₂ between pixel columns of RG in the first and second columns, namely, a sub-pixel of R and a sub-pixel of G are arranged symmetrically (line-symmetrically) relative to an axial line O passing at a center between the signal lines 33₁ and 33₂ (so-called mirror inverted arrangement). Additionally, in the sub-pixel of R and the sub-pixel of G, a gate electrode 23_{G} of the writing transistor 23 to write, in each of the pixels, a video signal supplied to each of the signal lines 33₁ and 33₂ includes a common electrode. The gate electrode 23_{G} including such a common electrode is electrically connected to a scanning line 31 via a contact portion 36.

Thus, since the adjacent pixels (sub-pixels) 20 and 20 are arranged in a manner of the mirror inverted arrangement interposing the two signal lines 33₁ and 33₂ and the gate electrode 23_{G} of the writing transistor 23 of both pixels 20 and 20 is provided as a common electrode, definition of a display device can be improved. In other words, definition of the display device can be improved because more miniaturization of the pixel unit can be achieved compared to a case of adopting a configuration in which different gate electrodes 23_{G} of the writing transistors 23 of the adjacent pixels 20, 20 are provided and electrically connected to the scanning line 31 via respective contact portions 36.

### EXAMPLE 3

Example 3 is a modified example of the Example 2. The Example 1 and Example 2 are examples in which one pixel to be a unit of a color image includes three sub-pixels of RGB. In contrast, the Example 3 is an example in which one pixel to be a unit of a color image includes four sub-pixels of RGBW. Luminance can be improved by adding, to the three sub-pixels of RGB, a sub-pixel that emits W (white) light.

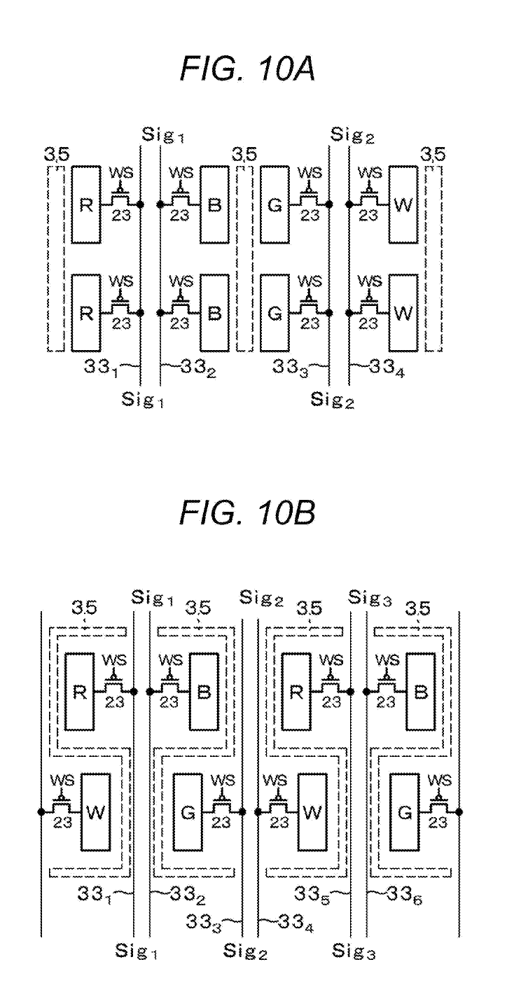

In a case where one pixel to be a unit of a color image includes the four sub-pixels of RGBW, a stripe array illustrated in FIG. 10A or a square array (square array) illustrated in FIG. 10B can be exemplified as an array of the sub-pixels. In the stripe array illustrated in FIG. 10A, colors are arrayed in the order of RBGW from a first column. The color array is not limited to this, but this color array is preferable due to reasons described later. However, positions of R and B, and positions of G and W may be switched. Furthermore, in the square array illustrated in FIG. 10B, provided is a color array in which R and B, and W and G are arranged side by side, and these pairs are vertically aligned. The color array is not limited to this, but this color array is preferable due to reasons described later. However, positions of R and B, and positions of G and W may be switched.

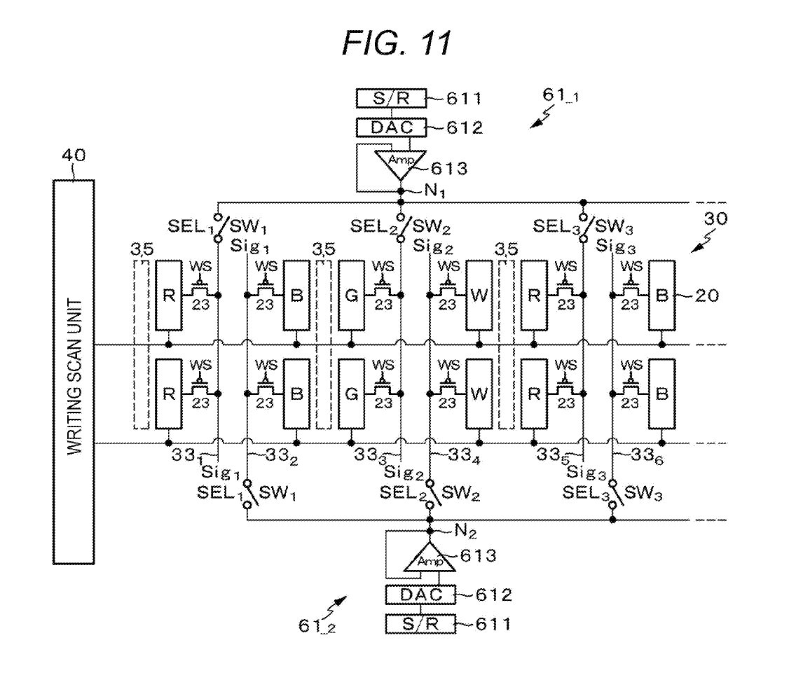

FIG. 11 is a block diagram illustrating an exemplary configuration of a video signal supply unit according to the Example 3 in a case of a stripe array. In the stripe array illustrated in FIG. 10A, the sub-pixels of G and W are sub-pixels having relatively high spectral luminous efficacy, and the sub-pixels of Rand B are sub-pixels having relatively low spectral luminous efficacy. Furthermore, in the Example 3, in a case where two adjacent pixel columns are set as a unit, one pixel to be a unit of a color image includes: sub-pixels belonging to one pair of two pixel columns and having relatively high spectral luminous efficacy; and sub-pixels belonging to the other pair of two pixel columns adjacent to the one pair of two pixel columns and having relatively low spectral luminous efficacy. In the following, a video signal supply unit 60 according to the Example 3 will be specifically described.

As illustrated in FIG. 11, a signal line 33₁ of a first column and a signal line 33₂ of a second column are provided close to each other, and a pixel column of Rand a pixel column of B corresponding to these signal lines 33₁ and 33₂ are arranged outside the signal lines 33₁ and 33₂. Furthermore, a signal line 33₃ of a third column and a signal line 33₄ of a fourth column are provided close to each other, and a pixel column of G and a pixel column of W corresponding to these signal lines 33₃, 33₄ are arranged outside the signal lines 33₃, 33₄. In the following, the similar arrangement is repeated.

Drivers 61__{¹} and 61__{²} of two systems located on upper and lower sides take roles to drive, per two colors, the four sub-pixels RBGW of this stripe array. In other words, video signals are supplied from the data drivers 61__{¹}, 61__{²}, of the two systems to the signal line 33₁ of the first column and the signal line 33₂ of the second column, the signal line 33₃ of the third column and the signal line 33₄ of the fourth column, . . . at the same timing, respectively. With this configuration, coupling does not occur, and therefore, the signal line 33₁ of the first column and the signal line 33₂ of the second column, the signal line 33₃ of the third column and the signal line 33₄ of the fourth column, . . . can be arranged close to each other. However, the supply timings of the video signals are different between the signal line 33₂ of the second column and the signal line 33₃ of the third column and between the signal line 33₄ of the fourth column and the signal lines 33₅ of the fifth column. Therefore, preferably, provided is a configuration in which shield portions 35 are provided between the pixel column of B in a second eye column and a pixel column of G in the third column, between the pixel column of W in the fourth column and the pixel column of R in the fifth row of R, . . . , respectively.

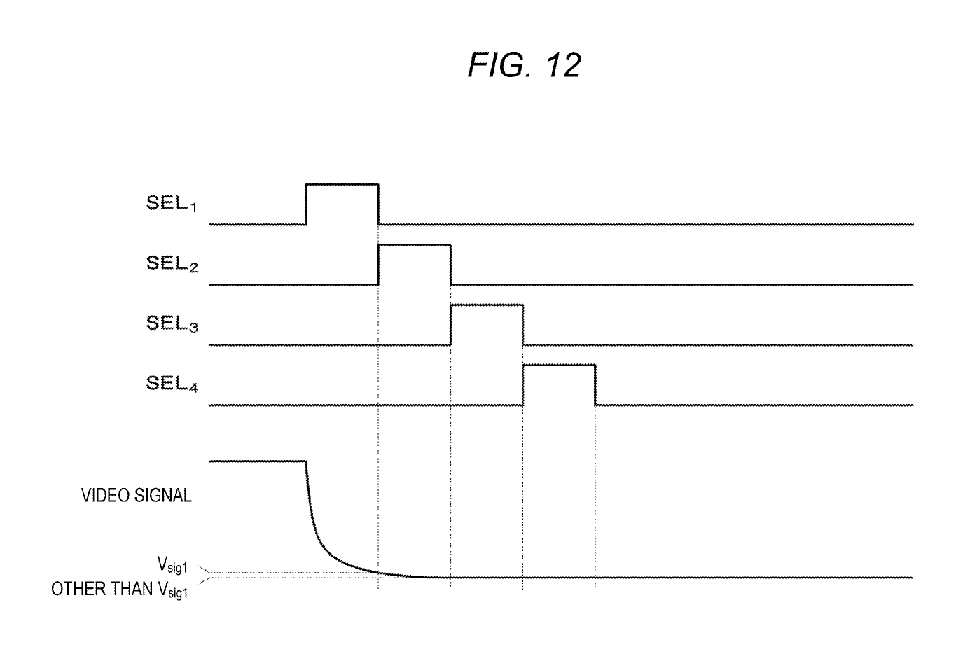

In the selector-driven video signal supply unit 60, selection signals SEL₁, SEL₂, . . . are sequentially applied, per two columns, from the data drivers 61__{¹} and 61__{²} of the two systems to switches SW₁, SW₂, . . . provided in the signal lines 33₁, 33₂, . . . of the respective pixel columns. FIG. 12 illustrates waveforms of the selection signals SEL₁, SEL₂, . . . to drive the switches SW₁, SW₂, . . . of the respective pixel columns and the video signals to be supplied to the signal lines 33₁, 33₂, . . ., respectively.

During the selector driving to stepwisely (sequentially) supply video signals to the signal lines 33₁, 33₂, from the data drivers 61__{¹} and 61__{²} of the two systems of in a time sharing manner, settling of the video signal to be written in an initial step (first step) becomes insufficient due to influence of wiring resistance and the like as illustrated in FIG. 12. Consequently, a signal voltage V_{sig1} held in each of the signal lines 33₁ and 33₂ in the initial step may be deviated (different) from a signal voltage V_{sig2} held in each of the signal lines 33₃, ³³₄, in second and subsequent steps.

Furthermore, in a case where a sub-pixel in which the signal voltage V_{sig1} is written in the initial step is each of the sub-pixels of GW having high spectral luminous efficacy, there is a concern that such a deviation of the signal voltage V_{sig1} may be easily visually recognized as vertical stripe noise. Considering this, in the Example 3, adopted is the configuration in which the color array having the order of RBGW from the first column, in other words, the color array in which the sub-pixels of RB having relatively low spectral luminous efficacy are arrayed in the first column and the second column, and the sub-pixels of GW having relatively high spectral luminous efficacy are arrayed in the third column and the fourth column. However, positions of R and B, and positions of G and W may be switched.

With this configuration, in a case of stepwisely supplying video signals in a unit of two adjacent signal lines in a time sharing manner, the video signals are supplied to the signal lines 33₁ and 33₂ connected to the sub-pixels RB having the low spectral luminous efficacy in the initial step. Additionally, in the second and subsequent steps, the video signals are supplied to the signal lines 33₃ and 33₄ connected to the sub-pixels GW having high spectral luminous efficacy. As a result, even in a case where the signal voltage V_{sig1} in the initial step is deviated from the signal voltages V_{sig2} of the second and subsequent steps, such a deviation of the signal voltage V_{sig1} is hardly visually recognized as vertical stripe noise because the signal voltage V_{sig1} to be written in the initial step are the sub-pixels RB having the low spectral luminous efficacy.

In a case where a pixel to be a unit to form a color image includes the four sub-pixels RGBW, it can be considered from the above description that it is preferable to make a pair of R (red) and G (green) and a pair of B (blue) and W (white) at the time of allocating these colors in a unit of two colors to the upper and lower data drivers 61__{¹} and 61__{²} of the two system. Additionally, considering simultaneous writing in adjacent two pixels (sub-pixels), it is preferable to adopt the color array of FIG. 10A in a case of arranging the four sub-pixels RGBW in the stripe array, and adopt the color array of FIG. 10B in a case of arranging the sub-pixels in the square array.

### EXAMPLE 4

Example 4 is a modified example of the Example 3, and particularly, the modified example of a wiring structure of the signal lines in the square array illustrated in FIG. 10B.

In the example of FIG. 10B, provided is the wiring structure in which the signal lines 33₁ and 33₂ are wired between the two sub-pixels of the paired RB, the signal lines 33₃ and 33₄ are wired between the two sub-pixels of the paired GW, and the shield portion 35 is provided between a set of the signal lines 33₁ and 33₂ and a set of the signal lines 33₃, and 33₄. This wiring structure has a structure in which the signal lines 33₁, 33₂, . . . are wired in a planar manner. Therefore, the wiring structure is applicable to a case of using an insulation substrate such as a glass substrate and also a case of using a semiconductor substrate such as a silicon substrate as the substrate of the display panel 70.

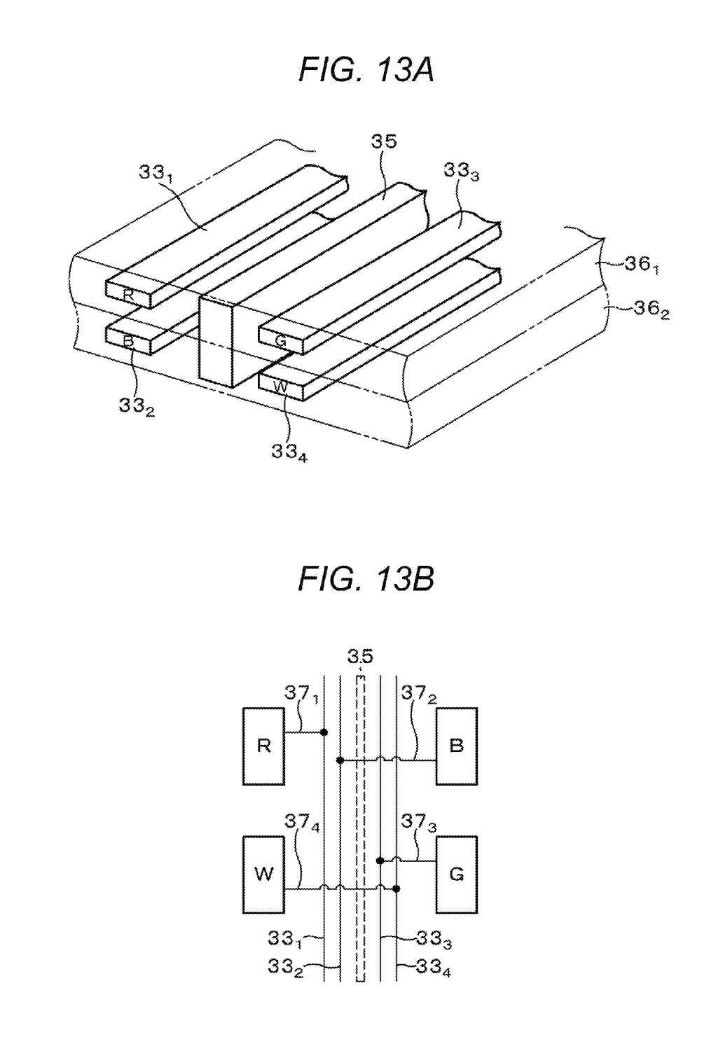

FIG. 13A schematically illustrates a first modified example of the wiring structure in the square array, and FIG. 13B schematically illustrates a second modified example of the wiring structure in the square array. In these first and second modified examples, it is assumed that a semiconductor substrate such as a silicon substrate is used as the substrate of the display panel 70. In a case of the semiconductor substrate, there is an advantage that wiring layers that form signal lines can have a multi-layer structure.

In the wiring structure in the square array according to the first modified example illustrated in FIG. 13A, the wiring layers that form the signal lines has a two-layer structure. In the two-layer structure, a signal line 33₁ connected to a sub-pixel of R and a signal line 33₃ connected to a sub-pixel of G are formed in an upper wiring layer 36₁, and a signal line 33₂ connected to a sub-pixel of B and a signal line 33₄ connected to a sub-pixel of W are formed in a lower wiring layer 36₂. Additionally, a shield portion 35 is provided between the signal line 33₁ and the signal line 33₃ and between the signal line 33₂ and the signal line 33₄.

Thus, since a stacking structure is adopted for the wiring structure of the signal lines 33₁, 33₂, . . . , not only more miniaturization of a pixel unit but also more improvement of definition of the display device can be achieved compared to a planar wiring structure.

In the wiring structure in the square array according to the second modified example illustrated in FIG. 13B, four signal lines 33₁, 33₂, 33₃, and 33₄ connected to these four sub-pixels are collectively wired between two sub-pixels of RB to be paired and between two sub-pixels of GW to be paired. Furthermore, a shield portion 35 is provided between a set of the signal lines 33₁ and 33₂ connected to the sub-pixels of RB and a set of the signal lines 33₃ and 33₄ connected to the sub-pixels of GW.

A wire 37₁ that connects the sub-pixel of R to the signal line 33₁ is formed in the same wiring layer where the signal line is formed, and directly connected to the signal line 33₁. On the other hand, a wire 37₂ that connects the sub-pixel of B to the signal line 33₂, a wire 37₃ that connects the sub-pixel of G to the signal line 33₃, and a wire 37₄ that connects the sub-pixel of W to the signal line 33₄ are formed in a wiring layer different from the wiring layer where the signal lines are formed. Accordingly, the wire 37₂, wire 37₃, and wire 37₄ are connected to the signal line 33₂, signal line 33₃, and signal line 33₄ via contact holes, respectively. <Electronic Apparatus>

The above-described display device of the present disclosure is used as a display unit (display device) of an electronic apparatus in any field to display, as an image or a video, a video signal received in the electronic apparatus or a video signal generated in the electronic apparatus. Examples of the electronic apparatus can include a mobile terminal device such as a television set, a notebook personal computer, a digital still camera, and a mobile phone, a head mount display, and the like. However, examples are not limited thereto.

Following effects can be obtained by using the display device of the present disclosure as a display unit in an electronic apparatus in any field. In other words, according to the technology of the present disclosure, higher definition of a display unit can be achieved because it is possible to miniaturize a pixel unit.

The display device of the present disclosure also includes a module-shaped component having a sealed configuration. For example, a display module formed by pasting a counter portion such as transparent glass to a pixel array unit is applied. Note that the display module may be provided with a circuit unit in order to receive and output a signal and the like to a pixel array unit from outside, a flexible printed circuit (FPC), and the like. In the following, a digital still camera and a head mounted display will be exemplified as specific examples of the electronic apparatus using the display device of the present disclosure. However, note that the specific examples exemplified here are merely examples, and the present invention is not limited thereto.

### Specific Example 1

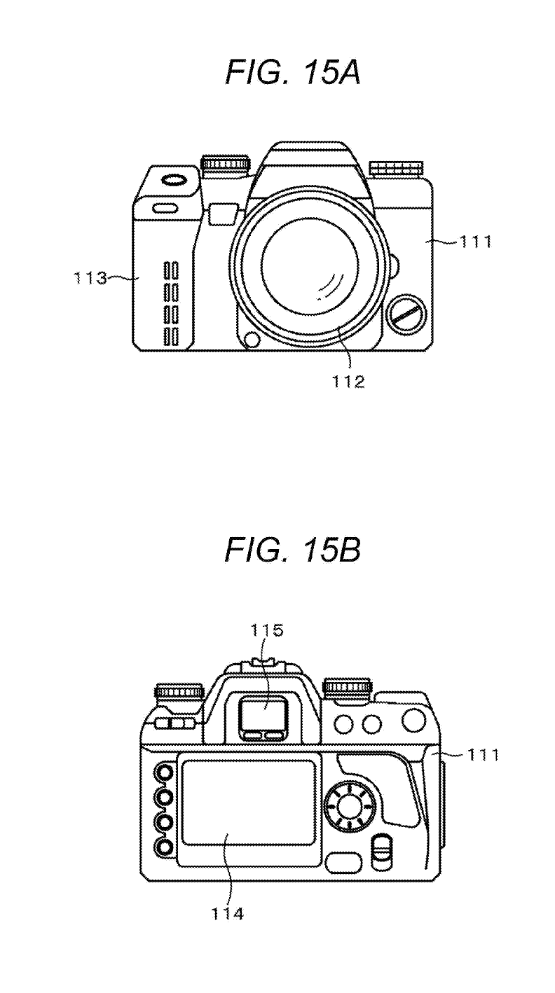

FIG. 15 illustrates external views of a single lens reflex digital still camera with interchangeable lenses, FIG. 15A illustrates a front view thereof, and FIG. 15B illustrates a rear view thereof. The single lens reflex digital still camera with interchangeable lenses includes, for example: an interchangeable photographing lens unit (interchangeable lens) 112 on a front right side of a camera main body (camera body) 111; and a grip portion 113 on a front left side to be gripped by a photographer.

Additionally, a monitor 114 is provided substantially at a center of a rear surface of the camera main body 111. A view finder (eyepiece window) 115 is provided above the monitor 114. A photographer can visually recognize an optical image of a subject guided from the photographing lens unit 112 and determine composition by looking into the view finder 115.

In the single lens reflex digital still camera with interchangeable lenses having the above-described configuration, the display device of the present disclosure can be used as the viewfinder 115. In other words, the single lens reflex digital still camera with interchangeable lenses according to the present example is manufactured by using the display device of the present disclosure as the view finder 115 therefor.

### Specific Example 2

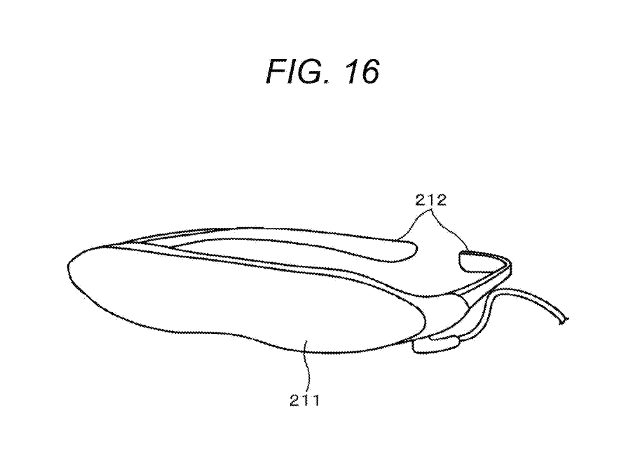

FIG. 16 is an external view of a head mounted display. The head mounted display includes, on both sides of a display unit 211 shaped like glasses, ear hooking portions 212 used for attachment to a user's head, for example. In this head mounted display, the display device of the present disclosure can be used as the display unit 211. In other words, the head mounted display according to the present example is manufactured by using the display device of the present disclosure as the display unit 211 therefor.

### Modified Example

While the display device and the electronic apparatus of the present disclosure have been described on the basis of the preferred embodiment, the display device and the electronic apparatus of the present disclosure are not limited to the above-described embodiment. The configurations and structures of the display device and the electronic apparatus described in the above-described embodiment are examples and can be suitably changed. For example, in the above-described embodiment, the selector driving system has been described as an example of a driving system in which supply timings (writing timings) of video signals to adjacent signal lines are different, but the present invention can be applied also to a dot sequence driving system, similarly.

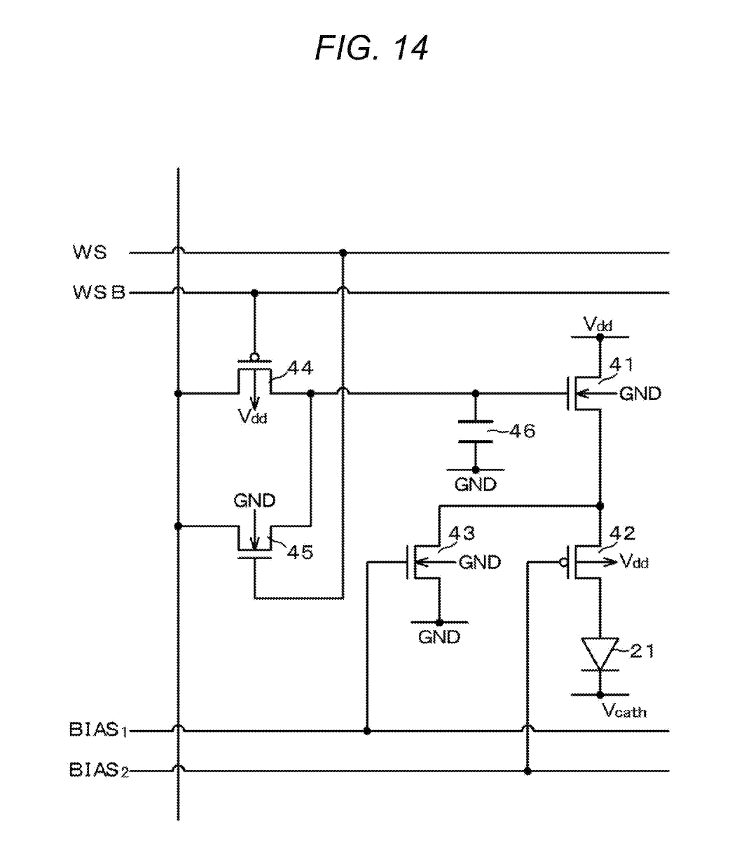

Additionally, in the above-described embodiment, a 3Tr2C circuit configuration including three transistors (Tr) 22 to 24 and two capacitive elements (C) 25 and 26 is exemplified as a pixel 20, but the circuit configuration of the pixel 20 is not limited to the 3Tr2C circuit configuration. For example, in the pixel circuit illustrated in FIG. 2, a 2Tr1C circuit configuration omitting the transistor 24 and the capacitive element 26 may also be applicable. Furthermore, as illustrated in FIG. 14, a 5Tr1C circuit configuration including five transistors 41 to 45 and one capacitive element 46 may also be applicable.

Furthermore, the present disclosure can also have following configurations.

[1] A display device including:

a pixel array unit in which pixels each including a light emitting portion are arranged in a matrix form; and

a video signal supply unit adapted to supply a video signal to a signal line provided per pixel column of the pixel array unit,

in which the video signal supply unit includes drivers of a plurality of systems provided in a manner corresponding to a plurality of adjacent signal lines.

[2] The display device recited in [1] above, in which the drivers of the plurality of systems supply video signals to the plurality of adjacent signal lines at the same timing.

[3] The display device recited in [1] or [2] above, in which the video signal supply unit sets, as a unit, a plurality of signal lines each provided per pixel column of the pixel array unit, and supplies video signals to the plurality of signal lines set as the unit in a time sharing manner.

[4] The display device recited in any one of [1] to [3] above, in which two signal lines provided close to each other are set as the plurality of adjacent signal lines, and the two pixel columns corresponding to the two signal lines are arranged outside the two signal lines.

[5] The display device recited in [4] above, in which the adjacent pixels interposing the two signal lines between the two pixel columns are arranged symmetrically with respect to an axial line passing at a center between the two signal lines.

[6] The display device recited in [5] above, in which

a pixel has a writing transistor to write, in the pixel, a video signal to be supplied to a signal line, and

a gate electrode of each of the writing transistors of the adjacent pixels interposing the two signal lines between the two pixel columns includes a common electrode.

[7] The display device recited in any one of [1] to [6] above, in which

in a case where two adjacent pixel columns are set as a unit, a pixel includes: sub-pixels belonging to one pair of two pixel columns and having relatively high spectral luminous efficacy; and sub-pixels belonging to the other pair of two pixel columns adjacent to the one pair of two pixel columns and having relatively low spectral luminous efficacy, and

a shield portion is provided between a set of signal lines of the one pair of two pixel columns and a set of signal lines of the other pair of two pixel columns.

[8] The display device recited in [7] above, in which, in a case of stepwisely supplying video signals in a unit of two adjacent signal lines in a time sharing manner, the video signal supply unit supplies the video signals to signal lines connected to the sub-pixels having relatively low spectral luminous efficacy in the initial step, and supplies the video signals to signal lines connected to the sub-pixels having relatively high spectral luminous efficacy in second and subsequent steps.

[9] The display device recited in [8] above, in which

a pixel includes four sub-pixels including a red sub-pixel, a green sub-pixel, a blue sub-pixel, and a white sub-pixel, and

the video signal supply unit supplies video signals to signal lines connected to the red sub-pixel and the sub-pixel of the blue sub-pixel in the initial step and supplies video signals to signal lines connected to the green sub-pixel and the white sub-pixel in the second and subsequent steps.

[10] The display device recited in [9] above, in which the adjacent pixels between the two pixel columns corresponding to the two signal lines include: a pair of the red sub-pixel and the blue sub-pixel; and a pair of the green sub-pixel and the white sub-pixel.

[11] An electronic apparatus including a display device including:

a pixel array unit in which pixels each including a light emitting portion are arranged in a matrix form; and

a video signal supply unit adapted to supply a video signal to a signal line provided per pixel column of the pixel array unit,

in which the video signal supply unit includes drivers of a plurality of systems provided in a manner corresponding to a plurality of adjacent signal lines.

### REFERENCE SIGNS LIST

10 Organic EL display device
20 Pixel (pixel circuit)
21 Organic EL element
22 Driving transistor
23 Writing transistor
24 Light emission control transistor
25 Storage capacitor
26 Auxiliary capacitor
30 Pixel array unit
31(31₁ to 31ₘ) Scanning line
32(32₁ to 32ₘ) Driving line
33 (33₁ to 33ₙ) Signal line
34 Common power supply line
35 Shield portion
40 Writing scan unit
50 Driving scan unit
60 Video signal supply unit
61 Data driver
62 Selector circuit
70 Display panel

1. A display device comprising:
a pixel array unit in which pixels each including a light emitting portion are arranged in a matrix form; and
a video signal supply unit configured to supply a video signal to a signal line provided per pixel column of the pixel array unit,
wherein the video signal supply unit includes drivers of a plurality of systems provided in a manner corresponding to a plurality of adjacent signal lines.

2. The display device according to claim 1, wherein the drivers of the plurality of systems supply video signals to the plurality of adjacent signal lines at the same timing.

3. The display device according to claim 1, wherein the video signal supply unit sets, as a unit, a plurality of signal lines each provided per pixel column of the pixel array unit, and supplies video signals to the plurality of signal lines set as the unit in a time sharing manner.

4. The display device according to claim 1, wherein two signal lines provided close to each other are set as the plurality of adjacent signal lines, and the two pixel columns corresponding to the two signal lines are arranged outside the two signal lines.

5. The display device according to claim 4, wherein the adjacent pixels interposing the two signal lines between the two pixel columns are arranged symmetrically with respect to an axial line passing at a center between the two signal lines.

6. The display device according to claim 5, wherein
a pixel has a writing transistor to write, in the pixel, a video signal to be supplied to a signal line, and
a gate electrode of each of the writing transistors of the adjacent pixels interposing the two signal lines between the two pixel columns includes a common electrode.

7. The display device according to claim 1, wherein
when two adjacent pixel columns are set as a unit, a pixel includes: sub-pixels belonging to one pair of two pixel columns and having relatively high spectral luminous efficacy; and sub-pixels belonging to the other pair of two pixel columns adjacent to the one pair of two pixel columns and having relatively low spectral luminous efficacy, and
a shield portion is provided between a set of signal lines of the one pair of two pixel columns and a set of signal lines of the other pair of two pixel columns.

8. The display device according to claim 7, wherein, in a case of stepwisely supplying video signals in a unit of two adjacent signal lines in a time sharing manner, the video signal supply unit supplies the video signals to signal lines connected to the sub-pixels having relatively low spectral luminous efficacy in the initial step, and supplies the video signals to signal lines connected to the sub-pixels having relatively high spectral luminous efficacy in second and subsequent steps.

9. The display device according to claim 8, wherein
a pixel includes four sub-pixels including a red sub-pixel, a green sub-pixel, a blue sub-pixel, and a white sub-pixel, and
the video signal supply unit supplies video signals to signal lines connected to the red sub-pixel and the sub-pixel of the blue sub-pixel in the initial step and supplies video signals to signal lines connected to the green sub-pixel and the white sub-pixel in the second and subsequent steps.

10. The display device according to item 9, wherein the adjacent pixels between the two pixel columns corresponding to the two signal lines include; a pair of the red sub-pixel and the blue sub-pixel; and a pair of the green sub-pixel and the white sub-pixel.

11. An electronic apparatus comprising a display device including:
a pixel array unit in which pixels each including a light emitting portion are arranged in a matrix form; and
a video signal supply unit configured to supply a video signal to a signal line provided for each pixel column of the pixel array unit,
wherein the video signal supply unit includes drivers of a plurality of systems provided in a manner corresponding to a plurality of adjacent signal lines.
